(19) United States
(12) Patent Application Publication
(10) Pub. No.: US 2002/0104541 A1
(43) Pub. Date: Aug. 8, 2002

(54) Devices, systems and methods for preventing collapse of the upper airway and sensors for use therein

(75) Inventors: Noam Bibi, Rehovot (IL); Nimrod Lev, Ganei Yehuda (IL)

Correspondence Address: DR. MARK FRIEDMAN LTD., c/o Bill Polkinghorn, Discovery Dispatch, 9003 Florin Way, Upper Marlboro, MD, 20772, US

(73) Assignee: DR. HAIM BIBI MEDICAL SERVICES LTD.

(21) Appl. No.: 10/103,915

(22) Filed: Mar. 25, 2002

Related U.S. Application Data
(63) Continuation-in-part of application No. 09/576,872, filed on May 22, 2000, now Pat. No. 6,371,112.

(51) Int. Cl. A62B 7/00; A62B 18/00; A62B 18/02; A62B 7/10; A62B 9/02

(52) U.S. Cl. 128/205.25; 128/204.18; 128/205.27; 128/200.24

(57) ABSTRACT

Devices, systems and methods for preventing collapse of the upper airway are disclosed. The device includes a mouthpiece and a breathing tube. The method includes the steps of inserting a mouthpiece and allowing inhaled air to flow through a breathing tube. A first disclosed system includes a CPAP device which maintains sufficient pressure in an upper airway while functioning independently of an external pressure source. The system includes, a mouthpiece, a breathing tube containing a bi-directional pressure sensitive valve and a mechanism for transforming kinetic energy of air flowing in a first direction to potential energy and transforming the potential energy to kinetic energy of air flowing in a second direction. Further disclosed is a method employing the system. An additional system includes a self contained CPAP for maintaining sufficient pressure in an airway while functioning independently of an external pressure source. The device includes a mouthpiece, a breathing tube containing a bi-directional pressure sensitive valve and an inflatable body. The inflatable body functions to adjust an internal cross sectional area of the breathing tube during a process of respiration, and to regulate air pressure during respiration. The device includes a mask designed and constructed to cover a nose of the patient and route exhaled air to the nose and a sensor.

This application is a CIP of Ser. No. 09/576,872 filed on May 22, 2000.

### FIELD AND BACKGROUND OF THE INVENTION

The present invention relates to self contained constant pressure applied proximally (CPAP) devices and to a systems and methods which prevent collapse of the upper airway. More particularly, the present invention relates to the use thereof for treatment of breathing disorders including, but not limited to, obstructive sleep apnea (OSA), apnea of infancy (AOI) and sudden infant death syndrome (SIDS). The present invention is further of devices, systems and methods which monitor parameters of air exhaled by a patient through such a device and of a physiologic status of a patient breathing through such a device.

OSA is a syndrome with significant morbidity and mortality (C. Guilleminault and M. Partinen (eds.) (1990) “Obstructive Sleep Apnea Syndrome: Clinical; Research and Treatment”. Raven Press, New York, N.Y., USA, pp xv-xvii). OSA is caused by repeated collapse of soft tissues forming the walls of the upper airway in the sub-glottal region during sleep (C. Guilleminault and M. Partinen, Ibid.). Opening of this portion of the airway depends upon the balance between negative pressure, which is at least −7 or −10 cm H₂O in normal quiet breathing (Levitzki MG (eds)(1986) “Pulmonary Physiology” McGraw-Hill Book Company, New York, N.Y., USA pp 37-40) outside the cavity caused by muscular action during breathing (e.g. action of the diaphragm and muscles surrounding the rib cage) and muscle tone in the upper airway itself (C. E. Sullivan et al., in C. Guilleminault and M. Partinen, Ibid., pp 49-69; S. T. Kuna et al. (1991) JAMA 266:1384-1389; J. E. Remmers et al., (1978) J. Appl. Physiol. 44:931-938; and D. J. Tangel et al. (1991) J. Appl. Physiol. 70:2574-2581). This repeated collapse of the upper airway causes a decrease in blood oxygen saturation which leads to sleep disturbances, fatigue and a general feeling of malaise in affected patients.

OSA is a common disorder with an estimated 2% of women and 4% of men being affected to a degree that treatment is advisable. This means that an estimated 12 to 18 million patients are affected in the USA. Since only about 7% to 18% of the population has been tested for this disorder, these estimates should be viewed as minimum estimates (C. Guilleminault in C. Guilleminault and E. Largesi (eds.) (1983) Raven Press, New York, N.Y., USA, pp 107-125; M. Partinen et al. (1988) Chest 94: 1200-1204; J. J E et al. (1988) Chest 94:9-14; National Commission on Sleep Disorders Research (1995) “Wake Up America: A National Sleep Alert” US Government Printing Office, Washington, D.C., USA, pp 2-10; T. Young et al. (1997) Sleep 20:705-706).

Currently accepted treatment for OSA typically includes continuous positive airway pressure (CPAP). CPAP, as currently practiced, involves connection of a pressurized air delivering device to the mouth or nose of the patient. This device typically is connected to a pressurized air source in the form of a compressor or tank with a regulator. These pressurized air supplies are expensive, large, and noisy.

Delivery of a constant flow of a breathable gas mixture through the device maintains a constant positive pressure in the upper airway. This constantly applied pressure prevents the collapse of the airway described hereinabove (C. E. Sullivan et al. (1981) Lancet 1:862-865; M. H. Sanders et al. (1983) Chest 83:144-145). CPAP is effective in treating OSA by preventing collapse of the airway and associated tiredness, fatigue, diminished intellectual function, and snoring and can even lengthen patient life expectancy (J. Hender et al. (1995) Eur. Respir. J. 8:222-229; H. Minemura et al. (1998) Intern. Med. 37: 1009-1013; C. Jenkinson et al. (1999) Lancet 353: 2100-2105).

In order to keep the pressure in the airway constant during inhalation and exhalation, a pressure valve is sometimes incorporated into the pressurized air delivering device. One such valve is taught by U.S. Pat. No. 4,298,023 for a spring loaded exhalation valve. Teachings of this patent specifically relate to treatment regimens which include a flow of gas delivered to the airway from a pressurized air supply.

However, patient compliance with CPAP treatment regimens is typically poor despite the proven efficacy of the treatment. Research suggests that 60 to 70% compliance is the norm and that the average patient use of CPAP is limited to 5 hours per night (N. P. Kribbs et al. (1993) Am. Rev. Respir. Dis. 147:887-895; H. Rauscher et al. (1993) Chest 103:1675-1680). In addition, many patients never begin treatment at all owing to the high cost of CPAP equipment.

Infants are typically obligatory nasal breathers (Shannon D C In: Disorders of the Respiratory Tract In Children—SIDS and Apnea in infancy Kendig & Chernick Eds (1990) W.B. Saunders Company, Philadelphia, Pa., USA pp 939-952.). Any change in airflows in the upper airways increase vulnerability to inadequate ventilation because: (1) the hypopharynx is shallow; (2) the tongue and epiglottis are more cephaled and (3) the mandible is more mobile (Tonkin S. (1975) Pediatrics 55:650-654). Normal infants typically have difficulty responding to nasal occlusion. Studies show that 44% of 6 week old infants struggled but failed to establish an oral airway when the nostrils were pinched for 25 seconds (Swift PGF et al (1973) Arch Dis Child 48:947-950). The physiologic basis for the failure to maintain adequate oral ventilation during occlusion in both normal and at risk infants is unknown. This mechanism has been suggested as a cause of AOI which can lead to SIDS (Anderson R B et al (1971) Biol Neonate 18:395-398.

There is thus a widely recognized need for, and it would be highly advantageous to have, devices, systems and methods which prevent collapse of the upper airway and are devoid of the above limitations. Further, monitoring of a parameter of exhaled air or patient physiology by such a device, system or method would increase utility thereof.

### SUMMARY OF THE INVENTION

According to one aspect of the present invention there is provided a self contained CPAP device. The device comprises; (a) a mouthpiece insertable in a mouth of a patient; (b) a breathing tube connecting between an outside environment and an interior of the mouth, the breathing tube containing at least one bi-directional pressure sensitive valve therein; (c) at least one inflatable body, the inflatable body functioning to adjust an internal cross sectional area of the breathing tube during a process of respiration, the inflatable body further serving to regulate an air pressure within the mouth during the process of respiration; and (d) a mask, the mask being in fluid communication with the inflatable body and being designed and constructed to cover a nose of the patient, such that exhaled air is routed thereto.

According to another aspect of the present invention there is provided a system for prophylactic treatment of a breathing disorder, the system comprising a self contained CPAP device, the device being designed and constructed to: (a) maintain sufficient pressure in an upper airway of a patient such that collapse thereof is prevented; and (b) function independently of any item selected from the group consisting of a pump, a compressor, a pressurized gas cylinder and an electro-hydrolytic oxygen source.

According to yet another aspect of the present invention there is provided an improved method of preventing a breathing disorder by means of CPAP, the method comprising the steps of: (a) inserting a mouthpiece in a mouth of a patient; (b) allowing inhaled air to flow through at least one bi-directional pressure sensitive valve contained within a breathing tube connecting between an outside environment and an interior of the mouth; (c) adjusting an internal cross sectional area of the breathing tube during a process of respiration by means of at least one inflatable body, the at least one inflatable body serving to regulate an air pressure within the mouth during the process of respiration and (d) covering a nose of the patient with a mask, the mask being in fluid communication with the at least one inflatable body and being designed and constructed to receive exhaled air therefrom and route the exhaled air to the nose of the patient. According to further features in preferred embodiments of the invention described below, the at least one inflatable body comprises: (i) at least one elastic balloon; (ii) at least one first additional unidirectional pressure sensitive valve in communication an interior of the breathing tube; and (iii) at least one second additional unidirectional pressure sensitive valve in communication with an exhaled air tube, the exhaled air tube being in communication with the mask;

According to still further features in the described preferred embodiments the at least one inflatable body comprises any number of inflatable bodies having a total inflated volume which is approximately 120 to 350 ml greater than a total deflated volume thereof such that it is suitable for use in adults.

According to still further features in the described preferred embodiments the at least one inflatable body comprises any number of inflatable bodies having a total inflated volume which is approximately 40 to 160 ml greater than a total deflated volume thereof such that it is suitable for use in children. According to still further features in the described preferred embodiments the at least one inflatable body comprises any number of inflatable bodies having a total inflated volume which is approximately 2 to 40 ml greater than a total deflated volume thereof such that it is suitable for use in infants.

According to still further features in the described preferred embodiments the at least one inflatable body comprises any number of inflatable bodies having a total inflated volume which is approximately 2 to 4 ml greater than a total deflated volume thereof for each Kg of mass of said patient.

According to still further features in the described preferred embodiments the inflatable body further comprises at least one unidirectional pressure sensitive safety valve in communication with the outside environment, the safety valve functioning to prevent explosion of the at least one inflatable body.

According to still further features in the described preferred embodiments the safety valve opens when a predetermined volume is exceeded.

According to still further features in the described preferred embodiments the mouthpiece is adjustable to fit the mouth of the patient.

According to still further features in the described preferred embodiments there is provided a mechanism for facilitating inflation of the mouthpiece.

According to still further features in the described preferred embodiments there is provided a mechanism for sealing between the mouthpiece and lips of the patient, such that airflow between the lips and the mouthpiece is diminished.

According to still further features in the described preferred embodiments the device further comprises a chin holder having a first end which is capable of engaging a chin of the patient and a second end which is connectable to the device.

According to still further features in the described preferred embodiments the breathing tube passes through the mouthpiece.

According to still further features in the described preferred embodiments the device further comprises at least one retaining piece for holding the device in place.

According to still further features in the described preferred embodiments the at least one retaining piece includes at least one item selected from the group consisting of at least one strap, at least one elastic band, at least one piece of Velcro™ and a pair of protrusions which engage the ears of the patient.

According to still further features in the described preferred embodiments the device further comprises a filter in the breathing tube, the filter designed and constructed to prevent the entry of foreign bodies thereto.

According to still further features in the described preferred embodiments the device is designed and configured for a purpose selected from the group consisting of treating obstructive sleep apnea, treating apnea of infancy and preventing sudden infant death syndrome.

According to still further features in the described preferred embodiments the device comprises: (i) a mouthpiece insertable in a mouth of a patient; (ii) a breathing tube connecting between an outside environment and an interior of the mouth, the breathing tube containing at least one bi-directional pressure sensitive valve therein; (iii) an inflatable body, the inflatable body functioning to adjust an internal cross sectional area of the breathing tube during a process of respiration, the at least one inflatable body further serving to regulate an air pressure within the mouth during the process of respiration; and (iv) a mask, the mask being in fluid communication with the at least one inflatable body and being designed and constructed to cover a nose of the patient, such that exhaled air is routed thereto.

According to still further features in the described preferred embodiments the at least one inflatable body comprises: (i) at least one elastic balloon; (ii) at least one first additional unidirectional pressure sensitive valve in communication an interior of the breathing tube; and (iv) at least one second additional unidirectional pressure sensitive valve in communication with an exhaled air tube, the exhaled air tube being in communication with the mask. This configuration assures that exhaled air passes through the first additional unidirectional pressure sensitive valve, thereby inflating the at least one inflatable body and causing an elevated pressure to form therein and that reducing of the elevated pressure is accomplished by a release of exhaled air through the second additional unidirectional pressure sensitive valve.

According to still further features in the described preferred embodiments there is provided at least one unidirectional pressure sensitive safety valve in communication with the outside environment such that exploding of the at least one inflatable body is prevented by release of the exhaled air through the safety valve when the elevated pressure exceeds a predefined limit.

According to still further features in the described preferred embodiments the method comprises the additional step of adjusting the mouthpiece to fit the mouth of the patient.

According to still further features in the described preferred embodiments the step of adjusting is accomplished by inflating the mouthpiece.

According to another aspect of the present invention there is provided a device for preventing collapse of the upper airway. The device includes a mouthpiece insertable in a mouth of a patient and a breathing tube connecting between an outside environment and an interior of the mouth.

According to yet another aspect of the present invention there is provided a method of preventing collapse of the upper airway. The method includes the steps of: (a) inserting a mouthpiece in a mouth of a patient; and (b) allowing inhaled air to flow through a breathing tube connecting between an outside environment and an interior of the mouth.

According to still another aspect of the present invention there is provided a system for prophylactic treatment of a breathing disorder. The system includes a self contained CPAP device. The device is designed and constructed to maintain sufficient pressure in an upper airway of a patient such that collapse thereof is prevented while functioning independently of any item selected from the group consisting of a pump, a compressor, a pressurized gas cylinder and an electro-hydrolytic oxygen source. The system includes: (i) a mouthpiece insertable in a mouth of a patient; (ii) a breathing tube connecting between an outside environment and an interior of the mouth, the breathing tube containing at least one bi-directional pressure sensitive valve therein; and (iii) a mechanism capable of transforming kinetic energy of air flowing in a first direction to potential energy and further transforming the potential energy to kinetic energy of air flowing in a second direction.

According to an additional aspect of the present invention there is provided an improved method of preventing a breathing disorder by means of CPAP. The method includes the steps of: (a) inserting a mouthpiece in a mouth of a patient; (b) allowing inhaled air to flow through at least one bi-directional pressure sensitive valve contained within a breathing tube connecting between an outside environment and an interior of the mouth; and (c) providing a mechanism capable of transforming kinetic energy of exhaled air flowing in a first direction to potential energy and further transforming the potential energy to kinetic energy of air flowing in a second direction into a proximal airway of the patient thereby regulating an air pressure within the mouth during the process of respiration.

According to yet another additional aspect of the present invention there is provided a system for prophylactic treatment of a breathing disorder, the system includes a self contained CPAP device. The device is designed and constructed to maintain sufficient pressure in an upper airway of a patient such that collapse thereof is prevented while functioning independently of any item selected from the group consisting of a pump, a compressor, a pressurized gas cylinder and an electro-hydrolytic oxygen source. The device includes: (i) a mouthpiece insertable in a mouth of the patient; (ii) a breathing tube connecting between an outside environment and an interior of the mouth, the breathing tube containing at least one bi-directional pressure sensitive valve therein; (iii) at least one inflatable body, the at least one inflatable body functioning to adjust an internal cross sectional area of the breathing tube during a process of respiration, the at least one inflatable body further serving to regulate an air pressure within the mouth during the process of respiration; (iv) a mask, the mask being in fluid communication with the at least one inflatable body and being designed and constructed to cover a nose of the patient, such that exhaled air is routed thereto; and (v) a sensor designed and constructed to measure a parameter selected from the group consisting of an air parameter and a patient parameter. For purposes of this specification and the accompanying claims, the term “sensor” refers equally to a single sensor or a combination of sensors capable of measuring, separately or in concert, at least one air or patient parameter or a combination thereof.

According to still further features in the described preferred embodiments the device further includes a humidifying element designed and constructed to add moisture to inhaled air.

According to still further features in the described preferred embodiments the device further includes a sensor in the breathing tube, the sensor designed and constructed to measure a parameter selected from the group consisting of an air parameter and a patient parameter.

According to still further features in the described preferred embodiments the system further includes a mask in fluid communication with the mechanism capable of transforming kinetic energy of air flowing in a first direction to potential energy and being designed and constructed to cover a nose of the patient, such that exhaled air is routed thereto.

According to still further features in the described preferred embodiments the method further includes covering a nose of the patient with a mask, the mask being in fluid communication with the mechanism capable of transforming kinetic energy of exhaled air and being designed and constructed to receive exhaled air therefrom and route the exhaled air to the nose of the patient.

According to still further features in the described preferred the sensor resides at a location selected from the breathing tube and the inflatable body.

The present invention successfully addresses the shortcomings of the presently known configurations by providing a CPAP device which is small, lightweight, portable, and relies primarily upon exhaled air as a source of pressure.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic representation of a device according to the present invention;

FIG. 2 depicts insertion of the device of FIG. 1 into a mouth of a patient;

FIG. 3 depicts a device according to the present invention as in FIG. 2 with the mask covering the nose of a patient;

FIGS. 4a, b, and c illustrate airflow through a device according to the present invention during an initial inspiration, an exhalation and all subsequent inhalations respectively;

FIG. 5 is a frontal view of the operative portion of a mechanism capable of transforming kinetic energy of air flowing in a first direction to potential energy and further transforming said potential energy to kinetic energy of air flowing in a second direction according to the present invention;

FIG. 6 is a lateral cross section of the mechanism illustrated in FIG. 5 installed as part of a system for prophylactic treatment of a breathing disorder according to the present invention in a first operational state;

FIG. 7 is a similar view of the system of FIG. 6 illustrating a second operational state thereof; and

FIG. 8 depicts a system according to FIGS. 6 and 7 in use.

### DESCRIPTION OF THE PREFERRED EMBODIMENTS

The present invention is of self contained constant pressure applied proximally (CPAP) devices and is further of systems and methods which prevent collapse of the upper airway which can be used for treatment of breathing disorders

Specifically, the present invention can be used to prevent or treat a variety of conditions including, but not limited to, obstructive sleep apnea (OSA), apnea of infancy (AOI) and sudden infant death syndrome (SIDS) and to improve patient compliance with recommended treatment protocols. The present invention is unique because it relies primarily upon exhaled air as a source of pressure.

The principles and operation of a self contained constant pressure applied proximally (CPAP) device and of systems and methods which prevent collapse of the upper airway according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

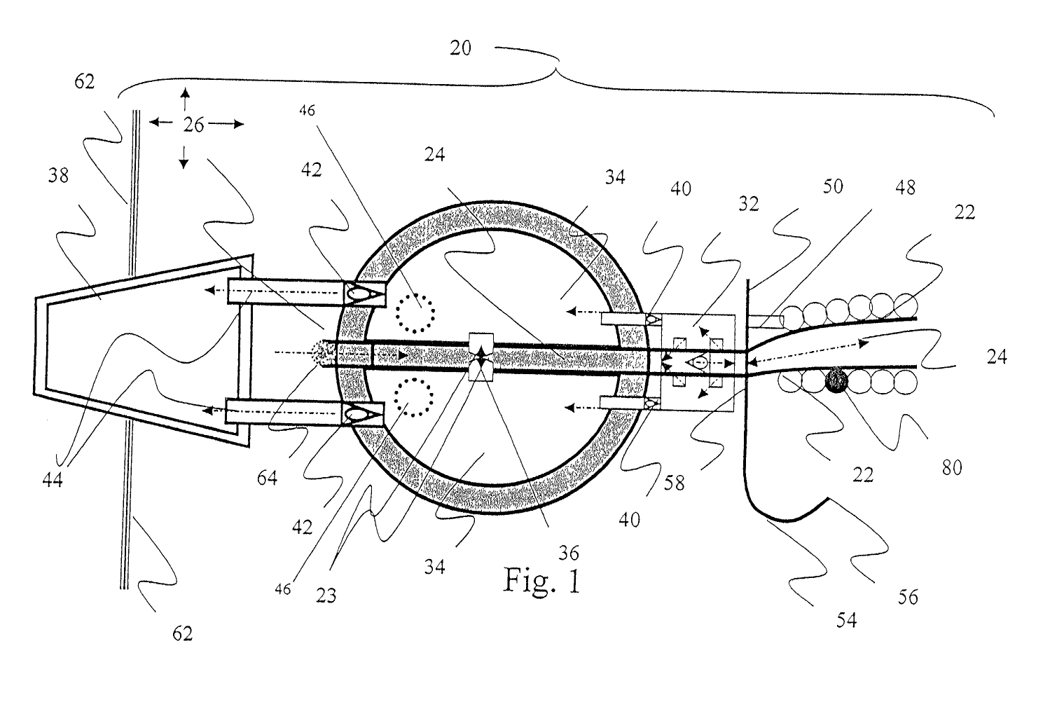

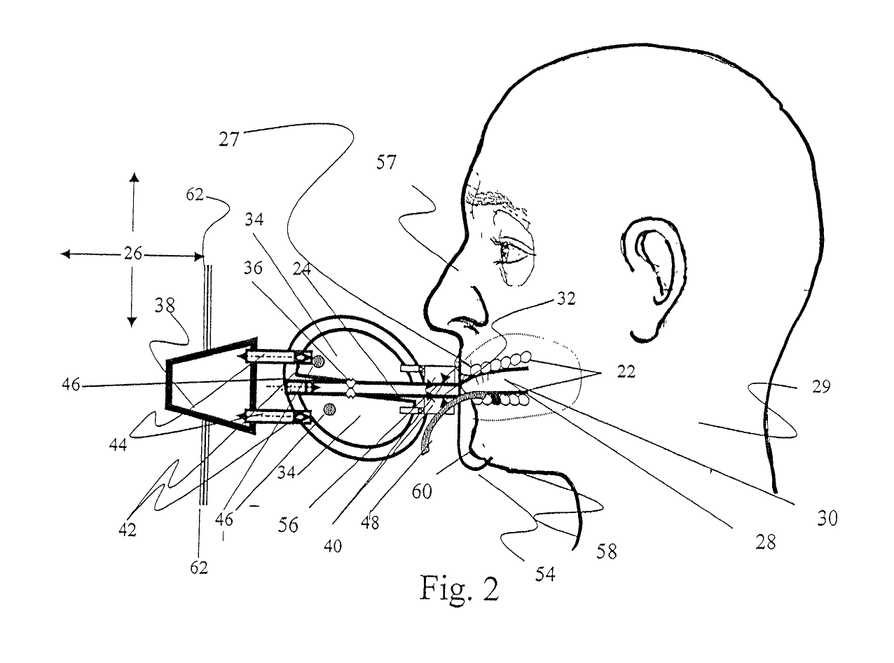

Referring now to the drawings, FIG. 1 illustrates the self contained CPAP device 20 of the present invention. Device 20 includes a mouthpiece 22 insertable in a mouth 28 (FIG. 2) of a patient. Mouthpiece 22 may be adjustable to fit the interior 30 of mouth 28 of the patient. According to some preferred embodiments of the present invention, a mechanism for facilitating inflation 48 of mouthpiece 22 is provided. According to preferred embodiments of the present invention there is provided a mechanism for sealing 50 between mouthpiece 22 and lips 27 of the patient, such that airflow between lips 27 and mouthpiece 22 is diminished.

According to preferred embodiments of the present invention device further includes a chin holder 54 having a first end 56 which is capable of engaging a chin 60 of the patient and a second end 58 which is connectable to the device.

Device 20 also includes a breathing tube 24 connecting between an outside environment 26 and an interior 30 of mouth 28. Breathing tube 24 contains at least one bi-directional pressure sensitive valve 32. Valve 32 serves to allow inhalation of air via tube 24 during inhalation, and to allow expiration of air during exhalation. Tube 24 has an internal cross sectional area 36 which changes during respiration as will be described hereinbelow. In the pictured embodiment of device 20, tube 24 has holes 23 therein.

In the pictured preferred embodiment breathing tube 24 passes through the mouthpiece to outside environment 26, although tube 24 could pass, for example between mouthpiece 22 and lips 27 without substantially effecting the function of device 20. In the pictured preferred embodiment (FIGS. 1, 2, and 3) tube 24 further includes a filter 25 designed and constructed to prevent the entry of foreign bodies thereto.

Device 20 also includes at least one inflatable body 34 which functions to adjust internal cross sectional area 36 of breathing tube 24 during a process of respiration. Inflatable body 34 further serves to regulate an air pressure within mouth 28 during the process of respiration. The process by which this regulation occurs is detailed hereinbelow. Inflatable body 34 includes at least one elastic balloon (also labeled 34), at least one first additional unidirectional pressure sensitive valve 40 in communication an interior of breathing tube 24 and at least one second additional unidirectional pressure sensitive valve 42 in communication with an re-inhaled air tube 44. Re-inhaled air tube 44 is in communication with a mask 38. This configuration assures that exhaled air passes through pressure sensitive valve 40, thereby inflating inflatable body 34 and causing an elevated pressure to form therein and that reduction of the elevated pressure is accomplished by a release of exhaled air through pressure sensitive valve 42 into re-inhaled air tube 44 which directs the re-inhaled air to mask 38.

Inflatable body 34 may include any number of inflatable bodies (two are pictured in the drawings) having a total inflated volume which is approximately 2 to 4 ml greater than a total deflated volume thereof for each Kg of mass of said patient. For example, inflatable body 34 might have a total inflated volume which is approximately 120 to 350 ml greater than a total deflated volume thereof such that it is suitable for use in adults, or it might have a total inflated volume which is approximately 40 to 160 ml greater than a total deflated volume thereof such that it is suitable for use in children, or it might have a total inflated volume which is approximately 2 to 40 ml greater than a total deflated volume thereof such that it is suitable for use in infants.

According to some preferred embodiments of device 20, inflatable body 34 further comprises at least one unidirectional pressure sensitive safety valve 46 in communication with the outside environment 26. Safety valve 46 functions to prevent explosion of inflatable body 34 by opening to release air to outside environment 26. Safety valve 46 opens when a predetermined inflated volume is exceeded. Since inflatable body 34 will have an elevated pressure as a volume thereof increases, safety valve 46 can also be said to release exhaled air when the elevated pressure exceeds a predefined limit.

Device 20 also includes mask 38 in fluid communication with inflatable body 34 by means of re inhaled air tube 44. Mask 38 is designed and constructed to cover a nose 57 of the patient, such that exhaled air is routed thereto. One ordinarily skilled in the art will be capable of modifying a commercially available mask for use with the present invention. Masks are available from, for example, www.respironics.co; www.sleep-net.com; and www.sunrisemedicalonline.com.

The present invention is further embodied by a system for prophylactic treatment of a breathing disorder. The system includes a self contained CPAP device which is designed and constructed to maintain sufficient pressure in an upper airway of a patient such that collapse thereof is prevented. Self contained CPAP device functions independently of, for example, a pump, a compressor, a pressurized gas cylinder and an electro-hydrolytic oxygen source.

The present invention is further embodied by an improved method of preventing a breathing disorder by means of CPAP. The method includes at least four steps. The first step includes inserting mouthpiece 22 in mouth 28 of a patient. The second step includes allowing inhaled air to flow through at least one bi-directional pressure sensitive valve 32 contained within breathing tube 24 which connects outside environment 26 and an interior 30 of mouth 28. The third step includes adjusting internal cross sectional area 36 of breathing tube 24 during a process of respiration by means of at least one inflatable body 34 which serves to regulate an air pressure within mouth 28 during the process of respiration. The fourth step includes covering nose 57 of the patient with mask 38 which is in fluid communication with inflatable body 34 and is designed and constructed to receive exhaled air therefrom and route the exhaled air to nose 57 of the patient. The method may sometimes include the additional step of adjusting mouthpiece 22 to fit mouth 28 of the patient. This additional step may be accomplished by, for example, inflating mouthpiece 22.

According to some preferred embodiments of the present invention, device 20 further comprises at least one retaining piece 62 for holding the device in place. Retaining piece 62 may include, for example, at least one strap, at least one elastic band, at least one piece of Velcro™ or a pair of protrusions which engage the ears 59 of the patient.

Device 20 may be specifically designed and configured for many purposes including, but not limited to, treating obstructive sleep apnea, treating apnea of infancy and preventing sudden infant death syndrome.

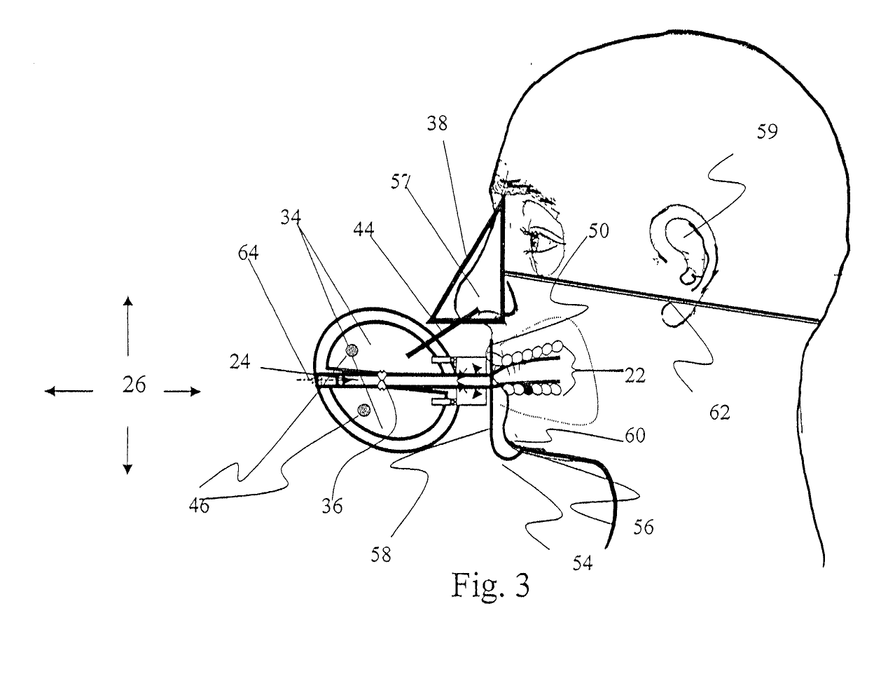

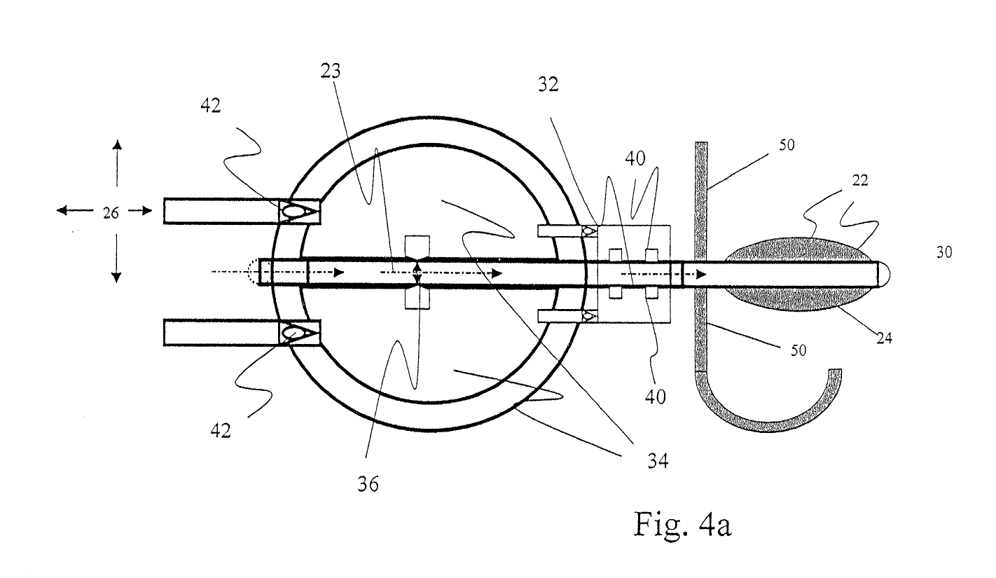

Having set forth the component parts of device 20, an explanation of their integrated function during respiration will now be provided. FIG. 4a shows the flow of air (arrows) from outside environment 26 via breathing tube 24 with internal cross sectional area 36 into interior of the mouth 30 during the first inhalation of a patient that has assembled device 20 on their face (as shown in FIG. 3). Flow of air through valve 32 is inward towards mouthpiece 22. Valve 32 opens at a very low pressure in this direction, for example 1 cm of H₂O or less. There is no flow of air at this stage through valves 40 and 42. Inflatable bodies 34 do not protrude through holes 23 because they are not yet inflated.

FIG. 4b shows the flow of air (arrows) during exhalation. Airflows outward from interior of mouth 30 via breathing tube 24 towards unidirectional valves 40 and bi-directional valve 32. Valves 40 open at a lower pressure than valve 32 so that exhaled airflows primarily into inflatable body 34 which begins to protrude through holes 23 in tube 24 as it expands, thereby reducing cross sectional area 36 of tube 24. Reduction of cross sectional area 36 of tube 24 is significant, for example reduced area 36 may be as little as one quarter or one eighth of initial area 36. As pressure within inflatable body 34 increases, valves 42, which communicate with re-inhaled air tube 44 (FIGS. 1, 2 and 3) open. This establishes a flow of air under slight positive pressure through nose 57 into interior of mouth 30 and subglottal region 29 of the airway. The positive pressure is preferably in excess of 12 cm of water, more preferably between 12 and 40 cm of water and most preferably approximately exactly 40 cm of water. This pressure also causes inflatable body 34 to expand through holes 23 in tube 24 thereby reducing cross sectional area 36 thereof. Approximately 300 ml of pressurized exhaled air collects in inflatable body 34 during exhalation. Because inflatable body 34 is elastic, this air continues to flow outward through valves 42 after exhalation ceases. Because valves 40 are unidirectional, air does not flow back into tube 24 from inflatable body 34. During exhalation, outward airflow through bi-directional valve 32 is partially obstructed because inflatable body 34 reduces cross sectional area 36 of tube 24 significantly as explained hereinabove. Inflatable body 34 also compresses partially elastic bi-directional valve 32 in order to allow some exhaled air to flow through tube 24 to outside environment 26.

During subsequent inhalations (FIG. 4c), air continues to flow outward through valves 42 maintaining positive pressure in the subglottal region 29 of the upper airway as described hereinabove. This outward flow reduces the volume of inflatable body 34 which tends to withdraw from holes 23 in tube 24 thereby increasing cross sectional area 36. Airflow during subsequent inhalations is otherwise as described for the first inhalation hereinabove.

Function of device 20 as described hereinabove is dependent to a large degree upon pressure differentials for operation of valves 32 and 40 and for operation of valves 40 and 42. In general, a pressure difference of 1 cm of water for each of these pairs should be sufficient to facilitate operation of device 20. One ordinarily skilled in the art will be able to assemble device 20 using commercially available valves from, for example, Hans Rudolph Inc. (Kansas City, Mo., USA). Valves 42 may be, in some preferred embodiments, two stage valves, such that inhalation via nose 57 is required to initiate release of exhaled air from inflatable body 34 via valves 42.

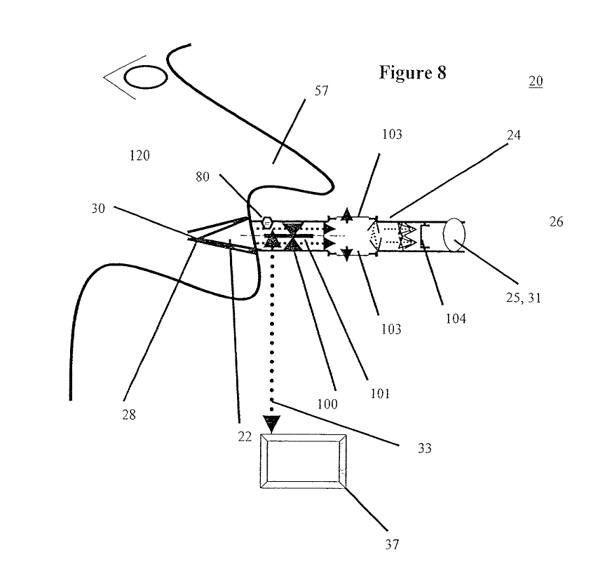

A simplified, and perhaps most preferred, embodiment of the present invention is a device 20 (FIGS. 1 and 8) for preventing collapse of the upper airway which includes a mouthpiece 22 insertable in mouth 28 of a patient and a breathing tube 24 connecting between an outside environment 26 and interior 30 of mouth 28. Preferably, mouthpiece 22 is adjustable to fit mouth 22 of the patient, for example by mechanism for inflating 48 (FIG. 1). As described hereinabove, breathing tube 24 preferably passes through mouthpiece 22. Preferably device 20 further includes a filter 25 designed and constructed to prevent the entry of foreign bodies into breathing tube 24 thereto. According to some preferred embodiments of the present invention device 20 further includes a humidifying element 31 designed and constructed to add moisture to inhaled air. Humidifying element 31 serves to prevent tissues dehydration in the mouth and airway. Preferably, filter 25 and humidifying element 31 are physically incorporated into a single unit as illustrated in FIG. 8. According to additional preferred embodiments of the present invention, device 20 further includes a sensor 80 in breathing tube 24. Sensor 80 is designed and constructed to measure a parameter such as, for example, an air parameter or a patient parameter. The air parameter may be, for example, air velocity, air volume or relative humidity. The patient parameter may be, for example, 02 saturation of the patient, a body temperature of the patient or a partial pressure of a gas in exhaled air. Partial pressure of a gas such as CO₂, O₂, CO or NO is specifically included in the definition of patient parameter, although partial pressures of other gases may be measured if they are deemed medically relevant. Air flow and air volume may be measured, for example, by a portable spirometer such as the Zephyr PC (Advanced Biosensor, Colombia S.C.) or another commercially available device.

Partial pressure of a gas may be measured, for example, using a miniaturized pulse oximeter such as those manufactured by Palco and Nonin and distributed by Aeromedix.com.

One of ordinary skill in the art of engineering will be able to incorporate a commercially available sensor into the context of the present invention. Sensor 80 is equipped with a display device 37 which registers data of the sensed parameter. Display 37 may be physically connected to device 20 or situated at a remote location, for example a nursing station. A channel of communication 33 facilitates transfer of data between sensor 80 and display 37. For purposes of this specification and the accompanying claims, the phrase “channel of communication” refers to a telephone connection, a cellular telephone connection, an Internet connection, an infrared frequency transmission connection, a local area network connection, a radio frequency connection, a fiber-optic connection or a connection by a wire. Inherent in the idea of a communication channel is an open status during which data transmission may occur. In some cases, communication channels may also have a closed status during which no data transmission may occur. Thus, according to some embodiments of the invention, patient 120 will monitor data displayed on display 37, which may be, for example, mounted on a wrist band, pocket or belt. According to other preferred embodiments of the invention, medical personnel will monitor data displayed on display 37. This monitoring may be local, for example by a personal nurse, or remote by means of established telemedicine techniques. Thus monitoring of data on display 37 may be constant, intermittent or periodic and may occur in real time or with a delay. Data processing capability is inherent in either sensor 80 or display 37 which may be, for example, the display of a personal computer.

Thus, the present invention is further embodied by a method of preventing collapse of the upper airway. The method includes inserting a mouthpiece 22 in a mouth of a patient and allowing inhaled air to flow through a breathing tube 24 connecting between an outside environment 26 and an interior 30 of mouth 28. This method includes all of the variations described hereinabove for device 20.

The present invention further provides a system for prophylactic treatment of a breathing disorder. The system includes a self contained CPAP device. The device 20 is designed and constructed to maintain sufficient pressure in an upper airway of a patient 120 such that collapse thereof is prevented. The system of the present invention functions without a pump, a compressor, a pressurized gas cylinder or an electro-hydrolytic oxygen source. The system includes mouthpiece 22 insertable in a mouth 28 of patient 120. The system further includes breathing tube 24 connecting between outside environment 26 and interior 30 of mouth 28. Breathing tube 24 contains at least one bi-directional pressure sensitive valve 32 therein or a pair of opposing unidirectional ports 103 and 104 which function together as a bi-directional pressure sensitive valve. The system further includes a mechanism capable of transforming kinetic energy of air flowing in a first direction to potential energy and further transforming the potential energy to kinetic energy of air flowing in a second direction. The mechanism capable of transforming kinetic energy of air flowing in a first direction to potential energy and further transforming the potential energy to kinetic energy of air flowing in a second direction may include, but is not limited to, an inflatable body 34 as described hereinabove or a turbine 100 as described hereinbelow. Preferably, the system further includes a mask 38 in fluid communication with the mechanism (e.g. 34 or 100) capable of transforming kinetic energy of air flowing in a first direction to potential energy and being designed and constructed to cover a nose 57 of patient 120, such that exhaled air is routed thereto. According to some preferred embodiments of the invention mouthpiece 22 and lips of patient 120 are sealed by mechanism for sealing 50 so that airflow between the lips and mouthpiece 22 is diminished.

It is often advantageous to incorporate a chin holder 54 having a first end which is capable of engaging a chin 60 of patient 120 and a second end which is connectable to device 20 so that device 20 is held firmly in place during use.

In most, but not all, configurations of device 20, breathing tube 24 passes through mouthpiece 22, although this is not essential to function of the system. As described hereinabove, device 20 is often constructed with at least one retaining piece. Preferably, device 20 further includes a filter 25 in breathing tube 24 as described hereinabove. Optionally, a humidifying element 31 may be included as described hereinabove.

The present invention is further embodied by an improved method of preventing a breathing disorder by means of CPAP. The method includes inserting mouthpiece 22 in mouth 28 of patient 120 and allowing inhaled air to flow through at least one bi-directional pressure sensitive valve 32 contained within breathing tube 24 connecting between outside environment 26 and an interior 30 of mouth 28. Valve 32 may be, for example, a pair of opposing unidirectional ports 103 and 104 which function together as a bi-directional pressure sensitive valve. The method further includes providing a mechanism (e.g. 34 or 100) capable of transforming kinetic energy of exhaled air flowing in a first direction to potential energy and further transforming the potential energy to kinetic energy of air flowing in a second direction into a proximal airway of the patient thereby regulating an air pressure within the mouth during the process of respiration. Preferably, the method further includes covering nose 57 of patient 120 with a mask 38 in fluid communication with the mechanism (e.g. 34 or 100) capable of transforming kinetic energy of exhaled air as described hereinabove.

According to yet another additional aspect of the present invention there is provided a system for prophylactic treatment of a breathing disorder including a self contained CPAP device 20 as described hereinabove and further including a sensor 80 designed and constructed to measure at least one parameter as described hereinabove. Sensor 80 may reside, for example, at a location selected from breathing tube 24 and inflatable body 34.

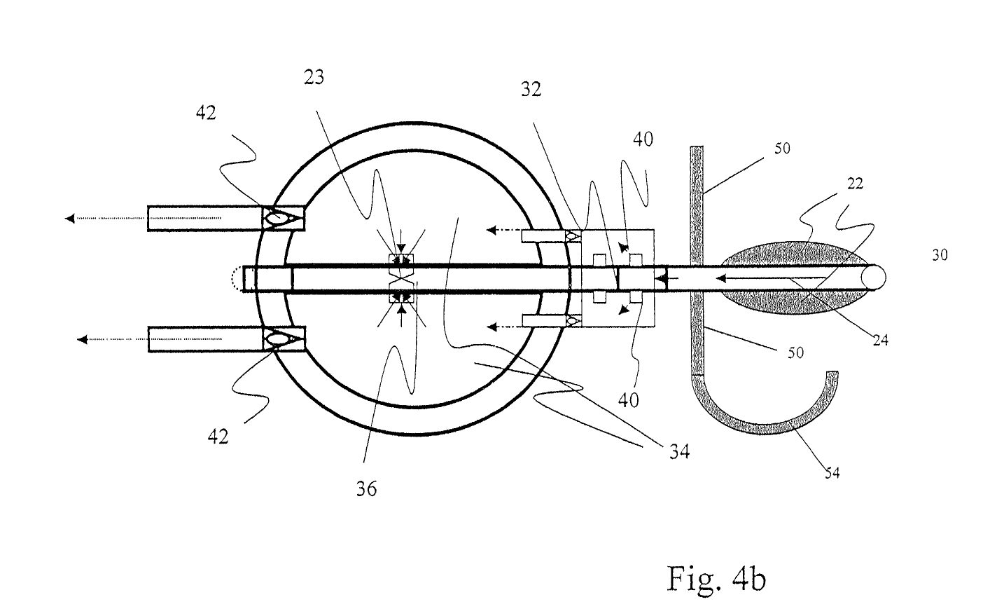

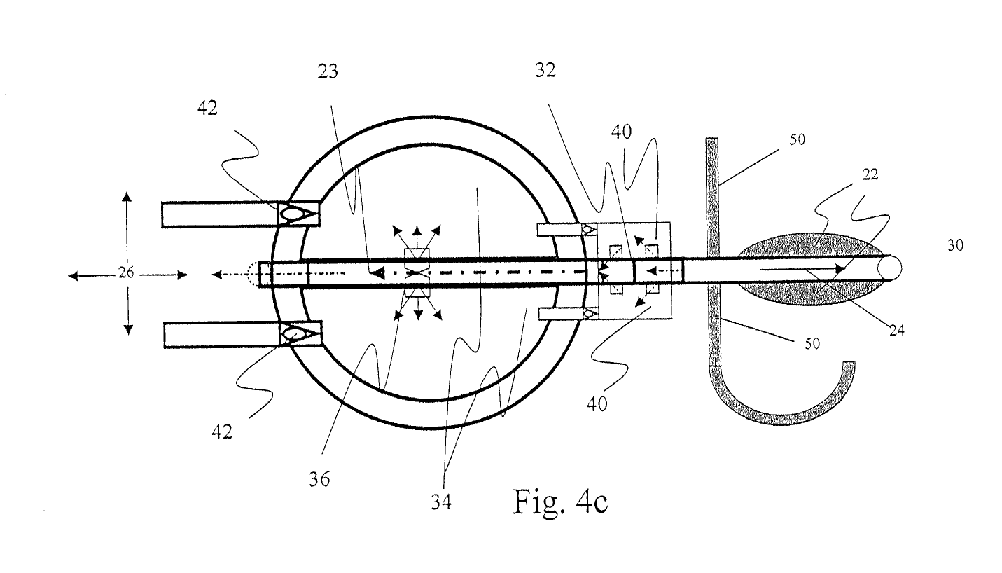

Workings of a mechanism capable of transforming kinetic energy of exhaled air in the form of inflatable body 34 have been described in detail hereinabove. Referring now to FIG. 5, an additional non-limiting example of such a mechanism will be provided. Turbine 100 which is capable of rotational motion in two directions (arrows) about an axis 101 is attached to energy storage component 102. The term turbine, as used herein, includes all configurations of airscrews, propellers or vanes which are capable of performing the function described herein. Energy storage component 102 may be, for example a coiled spring or elastic band. Exhaled air 105 (FIG. 6) flows outward via breathing tube 24 causing turbine 100 to rotate about axis 101 in a first direction thereby storing kinetic energy from exhaled air 105 as potential energy in energy storage component 102. Pressure sensitive unidirectional ports 103 and 104 function together as bi-directional pressure sensitive valve 32 in the pictured embodiment. This is preferable because it insures that some fresh air enters the system with each inhalation. Exhaled air 105 flows to outside environment 26 via ports 103. Port 104 remains closed in this operational state of device 20.

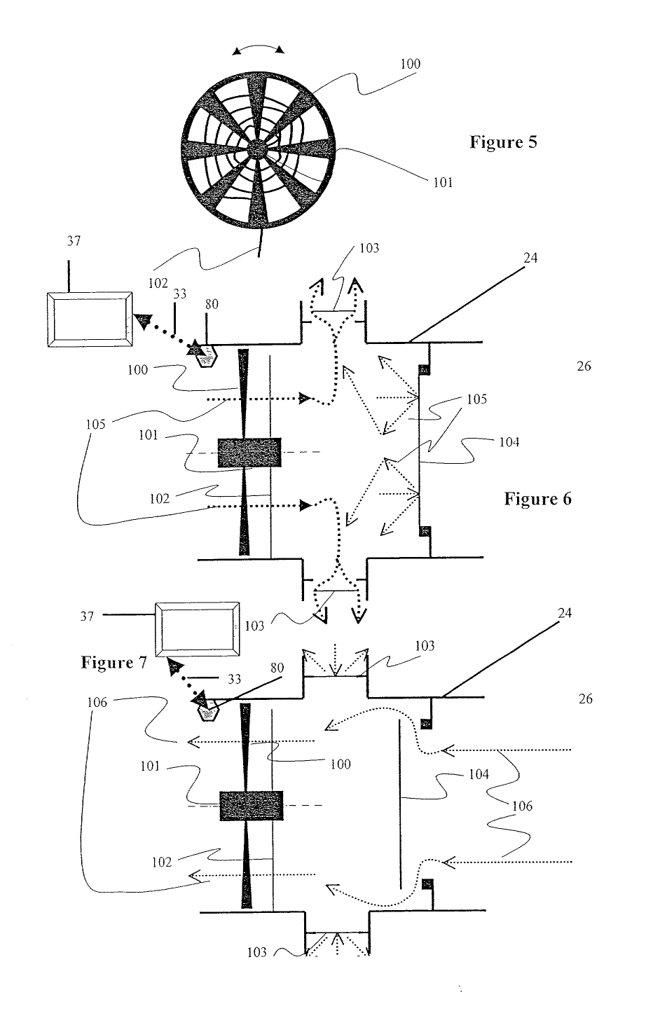

Inhalation (FIG. 7) occurs during a second operational state of device 20. Fresh air 106 flows inward via breathing tube 24 after entering via port 104. Concurrently, turbine 100 rotates about axis 101 in a second direction, activated by the release of stored potential energy from energy storage component 102. This pushes additional fresh air 106 from outside environment 26 into the airway of patient 120. Ports 103 remains closed in this operational state of device 20.

FIG. 8 depicts a device according to the present invention in use by a patient 120.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A device for preventing collapse of the upper airway, the device comprising:
(a) a mouthpiece insertable in a mouth of a patient; and
(b) a breathing tube connecting between an outside environment and an interior of said mouth.

2. The device of claim 1, wherein said mouthpiece is adjustable to fit said mouth of said patient.

3. The device of claim 1, wherein said breathing tube passes through said mouthpiece.

4. The device of claim 1, further comprising a filter in said breathing tube, said filter designed and constructed to prevent the entry of foreign bodies thereto.

5. The device of claim 1, further comprising a humidifying element designed and constructed to add moisture to inhaled air.

6. The device of claim 1, further comprising a sensor in said breathing tube, said sensor or sensors designed and constructed to measure a parameter selected from the group consisting of an air parameter and a patient parameter.

7. A method of preventing collapse of the upper airway, the method comprising the steps of:
(a) inserting a mouthpiece in a mouth of a patient; and
(b) allowing inhaled air to flow through a breathing tube connecting between an outside environment and an interior of said mouth.

8. The method of claim 7, comprising the additional step of adjusting said mouthpiece to fit said mouth of said patient.

9. The method of claim 7, wherein said breathing tube passes through said mouthpiece.

10. The method of claim 7, comprising the additional step of providing a filter in said breathing tube, said filter designed and constructed to prevent the entry of foreign bodies thereto.

11. The method of claim 7, comprising the additional step of providing a humidifying element designed and constructed to add moisture to inhaled air.

12. The method of claim 7, further comprising measuring, by means of a sensor in said breathing tube, a parameter selected from the group consisting of an air parameter and a patient parameter.

13. A system for prophylactic treatment of a breathing disorder, the system comprising a self contained CPAP device, said device being designed and constructed to:
(a) maintain sufficient pressure in an upper airway of a patient such that collapse thereof is prevented; and
(b) function independently of any item selected from the group consisting of a pump, a compressor, a pressurized gas cylinder and an electro-hydrolytic oxygen source, the system comprising:
(i) a mouthpiece insertable in a mouth of a patient;
(ii) a breathing tube connecting between an outside environment and an interior of said mouth, said breathing tube containing at least one bi-directional pressure sensitive valve therein; and
(iii) a mechanism capable of transforming kinetic energy of air flowing in a first direction to potential energy and further transforming said potential energy to kinetic energy of air flowing in a second direction.

14. The system of claim 13, further comprising:
(iv) a mask, said mask being in fluid communication with said mechanism capable of transforming kinetic energy of air flowing in a first direction to potential energy and being designed and constructed to cover a nose of said patient, such that exhaled air is routed thereto.

15. The system of claim 13, wherein said mouthpiece is adjustable to fit said mouth of said patient.

16. The system of claim 15, further comprising a mechanism for facilitating inflation of said mouthpiece.

17. The system of claim 13, further comprising a mechanism for sealing between said mouthpiece and lips of said patient, such that airflow between said lips and said mouthpiece is diminished.

18. The system of claim 13, further comprising a chin holder having a first end which is capable of engaging a chin of said patient and a second end which is connectable to the device.

19. The system of claim 13, wherein said breathing tube passes through said mouthpiece.

20. The system of claim 13, further comprising at least one retaining piece for holding the device in place.

21. The system of claim 13, further comprising a filter in said breathing tube, said filter designed and constructed to prevent the entry of foreign bodies thereto.

22. The system of claim 13, further comprising a humidifying element designed and constructed to add moisture to inhaled air.

23. The system of claim 13, further comprising a sensor in said breathing tube, said sensor designed and constructed to measure a parameter selected from the group consisting of an air parameter and a patient parameter.

24. An improved method of preventing a breathing disorder by means of CPAP, the method comprising the steps of:
(a) inserting a mouthpiece in a mouth of a patient;
(b) allowing inhaled air to flow through at least one bi-directional pressure sensitive valve contained within a breathing tube connecting between an outside environment and an interior of said mouth; and
(c) providing a mechanism capable of transforming kinetic energy of exhaled air flowing in a first direction to potential energy and further transforming said potential energy to kinetic energy of air flowing in a second direction into a proximal airway of said patient thereby regulating an air pressure within said mouth during said process of respiration.

25. The method of claim 24, further comprising:
(d) covering a nose of said patient with a mask, said mask being in fluid communication with said mechanism capable of transforming kinetic energy of exhaled air and being designed and constructed to receive exhaled air therefrom and route said exhaled air to said nose of said patient.

26. The method of claim 24, comprising the additional step of adjusting said mouthpiece to fit said mouth of said patient.

27. The method of claim 26, wherein said step of adjusting is accomplished by inflating said mouthpiece.

28. The method of claim 24, comprising the additional step of sealing between said mouthpiece and lips of said patient, such that airflow between said lips and said mouthpiece is diminished.

29. The method of claim 24, comprising the additional steps of engaging a chin of said patient with a first end of a chin holder and connecting a second end of said chin holder to an item selected from the group consisting of said mouthpiece, said breathing tube, said mechanism capable of transforming kinetic energy of exhaled air flowing in a first direction to potential energy and said mask.

30. The method of claim 24, wherein said breathing tube passes through said mouthpiece.

31. The method of claim 24, comprising the additional step of providing at least one retaining piece for holding said mouthpiece in place.

32. The method of claim 24, comprising the additional step of providing a filter in said breathing tube, said filter designed and constructed to prevent the entry of foreign bodies thereto.

33. The method of claim 24, comprising the additional step of providing a humidifying element designed and constructed to add moisture to inhaled air.

34. The method of claim 24, further comprising measuring, by means of a sensor in said breathing tube, a parameter selected from the group consisting of an air parameter and a patient parameter.

35. A system for prophylactic treatment of a breathing disorder, the system comprising a self contained CPAP device, said device being designed and constructed to:
(a) maintain sufficient pressure in an upper airway of a patient such that collapse thereof is prevented; and
(b) function independently of any item selected from the group consisting of a pump, a compressor, a pressurized gas cylinder and an electro-hydrolytic oxygen source;
wherein said device comprises:
(i) a mouthpiece insertable in a mouth of said patient;
(ii) a breathing tube connecting between an outside environment and an interior of said mouth, said breathing tube containing at least one bi-directional pressure sensitive valve therein;
(iii) at least one inflatable body, said at least one inflatable body functioning to adjust an internal cross sectional area of said breathing tube during a process of respiration, said at least one inflatable body further serving to regulate an air pressure within said mouth during said process of respiration;
(iv) a mask, said mask being in fluid communication with said at least one inflatable body and being designed and constructed to cover a nose of said patient, such that exhaled air is routed thereto; and
(v) a sensor designed and constructed to measure a parameter selected from the group consisting of an air parameter and a patient parameter.

36. The system of claim 35, wherein said sensor resides at a location selected from said breathing tube and said inflatable body.
